(19) United States
(12) Patent Application Publication
(10) Pub. No.: US 2025/0244182 A1
(43) Pub. Date: Jul. 31, 2025

(54) HEAT-SENSITIVE MATERIAL FOR AN OVERHEATING DETECTION ELEMENT, AND ASSOCIATED DETECTION ELEMENT, ELECTRICAL EQUIPMENT AND ELECTRICAL ENCLOSURE

(71) Applicant: Schneider Electric Industries SAS, Rueil-Malmaison (FR)

(72) Inventors: Patricia Spezzatti, La Terrasse (FR); Alexandra Argoud, Montbonnot-Saint-Martin (FR)

(73) Assignee: Schneider Electric Industries SAS, Rueil-Malmaison (FR)

(21) Appl. No.: 19/037,638

(22) Filed: Jan. 27, 2025

(30) Foreign Application Priority Data
Jan. 30, 2024 (FR) 2400891

(51) Int. Cl. G01K 11/00; C08K 3/04; C08K 5/12; C08K 5/435; G01K 11/06

(52) U.S. Cl. CPC G01K 11/003; C08K 3/04; C08K 5/12; C08K 5/435; G01K 11/06

(57) ABSTRACT

The present heat-sensitive material is a heat-injectable and electrically insulating material, the heat-sensitive material including a polymer matrix, made of a thermoplastic polymer material or of a thermoplastic elastomer, a plasticizer, having a molar weight (M), and a filler in the form of particles, in particular carbon black. The molar weight (M) of the plasticizer is chosen according to a first predetermined temperature threshold (Ti), such that the heat-sensitive material is configured to release volatile species from the heated plasticizer and filler particles entrained by the plasticizer when the heat-sensitive material is subjected to a temperature higher than the first temperature threshold (Ti), said volatile species from the plasticizer and filler particles being detectable by a detection device.

The present invention relates to a heat-sensitive material for detecting overheating, in particular for detecting overheating of an electrical equipment item. The invention also relates to an overheating detection element made of such a heat-sensitive material, to an electrical equipment item comprising such a detection element, and to an electrical cabinet comprising such an electrical equipment item.

In the field of electrical power devices of an electrical installation, electrical devices are usually located in an electrical cabinet, which forms a protective enclosure. Electrical devices are usually mounted on an electrical panel, which is as such received in the enclosure of the electrical cabinet. Each electrical device generally comprises one or more connection pads, to which electrically conductive members, such as cables or busbars respectively are connected. Typically, each electrically conductive member is, at one end, connected and fastened to one of the connection pads by means of a screw tightened into a nut.

In the assembled state, the screw passes through the electrically conductive member and the terminal strip and is screwed into the nut, pressing the electrically conductive member against the connection pad to secure the connection. If the connection between the electrically conductive member and the connection pad is loose, the electrical resistance of the connection increases, and when a current flows through the connection, localized heating occurs at the connection, which is a potential source of malfunction or even of accident if the heating exceeds a certain threshold and causes e.g. a fire. For normative and/or safety reasons, it is necessary to monitor the quality of the electrical connections, in particular by monitoring the heating of the connections and/or of the conductive members.

It is also known to take pictures using a thermal camera during inspection visits, in order to detect hot spots on an electrical panel. Only, the electrical box housing the panel has to be opened to take images, and for safety the electrical panel is often switched off, so the images taken do not accurately reflect the normal operation of the electrical devices and do not serve for continuous monitoring.

It is also known to install temperature probes, e.g. thermocouples or electronic temperature detectors, within the electrical panel for continuous monitoring of the electrical connections. However, the temperature probes, the installation thereof and the exploitation of the measurements thereof are expensive.

Another approach to the continuous monitoring of an electrical cabinet is to use a detection device apt to detect gaseous emissions, micro-particles and volatile organic compounds emitted when the cable sheaths are overheated. EP-3 512 056-A1 describes such an approach, which does not serve for a specific monitoring of a particular point in the electrical cabinet, more particularly connections that may become loose.

It is also known, in particular from EP-3 336 813-A2, to manufacture labels by incorporating micro-capsules into a polymer film having a predetermined melting temperature. The micro-capsules contain a specific gas, which is intended to be detected by a specific detection device. However, micro-capsules are relatively fragile and the implementation thereof remains tricky and limited to the manufacture of labels, which cannot be placed directly on electrical connections, e.g. on screwed connections. The labels have also to be placed one by one on the conductive elements to be monitored.

It is such problems that the invention particularly intends to remedy, by proposing a heat-sensitive material for detecting overheating, the heat-sensitive material serving for continuous monitoring, being easy to implement and being apt to adapt to different designs of parts.

To this end, the goal of the invention relates to a heat-sensitive material for an overheating detection element, wherein:
the heat-sensitive material is an electrically insulating, heat-injectable material, the heat-sensitive material including:
   a polymer matrix, made of a thermoplastic polymer material or thermoplastic elastomer having a first melting temperature,
   a plasticizer, having a molecular weight and a second melting temperature, the second melting temperature being lower than the first melting temperature, and
   a filler in the form of particles, in particular carbon black,
the molar weight of the plasticizer is chosen according to a first predetermined temperature threshold, the first threshold being strictly lower than the first melting temperature, so that the heat-sensitive material is configured to release volatile species coming from the heated plasticizer and filler particles entrained by the plasticizer when the heat-sensitive material is subjected to a temperature higher than the first temperature threshold, said volatile species coming from the plasticizer and from the filler particles being detectable by a detection device.

By means of the invention, the heat-sensitive material is a homogeneous material, which can be produced by conventional means without risk of deterioration, more particularly by hot injection, extrusion, etc. The implementation is particularly easy. It is thereby possible to shape the heat-sensitive material according to requirements, whether in the form of a flat and flexible plastic part that will be attached to the busbars, nut cladding, etc. Electrical equipment can thereby be provided with parts made of the heat-sensitive material as early as same are assembled in the factory, without requiring any additional operation during the assembly of the electrical panel, making it possible to continuously monitor the electrical equipment as soon as same is installed in the electrical cabinet. Of course, parts made of heat-sensitive material of any shape can be produced, to facilitate the installation thereof on the various electrical equipment items of an existing electrical cabinet, whether same are conductive elements or electrical devices.

According to advantageous but non-mandatory aspects of the invention, such a heat-sensitive material can incorporate one or a plurality of the following features, taken individually or according to any technically permissible combination:
The first temperature threshold is chosen between 125° C. ±10° C. and 160° C. ±10° C.,
for a first given temperature threshold, the molecular weight of the plasticizer is comprised between a minimum value and a maximum value,
on a graph linking the first temperature threshold on an x-axis to the molecular weight of the plasticizer on a y-axis, the first temperature threshold and the molar weight define a coordinate system, the first temperature threshold and the molar weight being located within a quadrilateral bounded by four points:
   a first point with the coordinates {115; 150},
   a second point with coordinates {115; 300},
   a third point with the coordinates {170; 525}, and
   a fourth point with the coordinates {170; 400}, respectively.
In graphical representation, the first temperature threshold and the molar weight are located inside a quadrilateral delimited by four points:
   a fifth point with the coordinates {115; 190},
   the second point with the coordinates {115; 300},
   the third point with the coordinates {170; 525}, and
   a sixth point with the coordinates {170; 450}, respectively.
In graphical representation, the first temperature threshold and the molar weight are located in a band bordered, on the bottom, by an intermediate segment connecting the fifth point to the sixth point, the band having a width, measured parallel to the y-axis, equal to 75 g/mol.
A degree of addition of the plasticizer is comprised between 4% and 15% by weight relative to the weight of the thermoplastic polymer matrix.
The filler is added between 2 and 3% by weight relative to the complete formulation of the heat-sensitive material.
The filler is carbon black.
The polymer matrix is polyethylene terephthalate, while the plasticizer is DINCH, added between 4% and 15% by weight relative to the polymer matrix.
The polymer matrix is polyamide 6/6, while the plasticizer is N-ethyl o/p-toluene sulfonamide, which is added between 4 and 15% by weight of the polymer matrix.
The polymer matrix is polybutylene terephthalate, while the plasticizer is N-ethyl o/p-toluene sulfonamide, which is added between 4 and 15% by weight of the polymer matrix.

The invention also relates to an overheating detection element, comprising a body made of the heat-sensitive material as described hereinabove.

The invention further relates to an electrical equipment item, which comprises an electrical conductor configured to be traversed by an electrical current, wherein:
the electrical equipment shall also include an overheating detection element as described hereinabove,
the overheating detection element is fastened to the electrical conductor.

The invention further relates to an electrical cabinet, wherein:
the electrical cabinet delimits an enclosure, and comprises:
   an electrical equipment item as described hereinabove;
   a detection device, configured to detect the flow of plasticizer and/or fillers released by the heat-sensitive material around the overheat detection element when the temperature of the heat-sensitive material exceeds the first temperature threshold,
the overheating detection element and the detection device are located in the enclosure of the electrical cabinet.

According to another aspect, the invention relates to a method for the detection of heating in an electrical cabinet, the detection method comprising:
providing an electrical cabinet as described hereinabove,
circulating an electric current through the electrical equipment item in such a way as to cause the overheating detection element to heat above the first temperature threshold and to release, around the body made of the heat-sensitive material, a flow of plasticizer and/or volatile species coming from the heated plasticizer and/or from filler particles entrained by the plasticizer,
detecting the flow of plasticizer and/or volatile species from the heated plasticizer and/or filler particles entrained by the plasticizer by means of the detection device.

Such method leads to the same advantages as the advantages mentioned hereinabove with regard to the detection of overheating according to the invention.

The invention will be better understood and other advantages of the invention will appear more clearly in the light of the following description of two embodiments of a heat-sensitive material for the detection of overheating, of a detection element, of an electrical equipment item, of an electrical cabinet and of a detection method, according to the principle thereof, given only as an example and made with reference to the enclosed drawings, wherein:

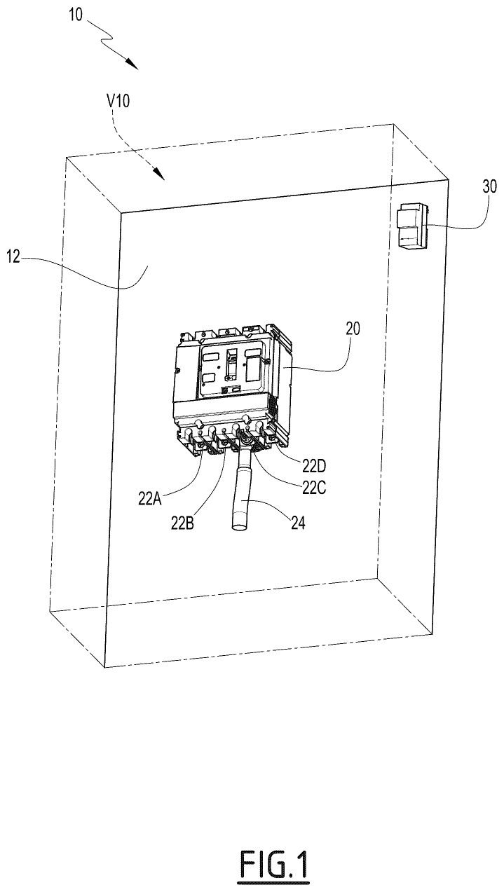

FIG. 1 is a schematic perspective view of an electrical cabinet according to the invention, the electrical cabinet comprising an electrical equipment item which is also according to the invention;

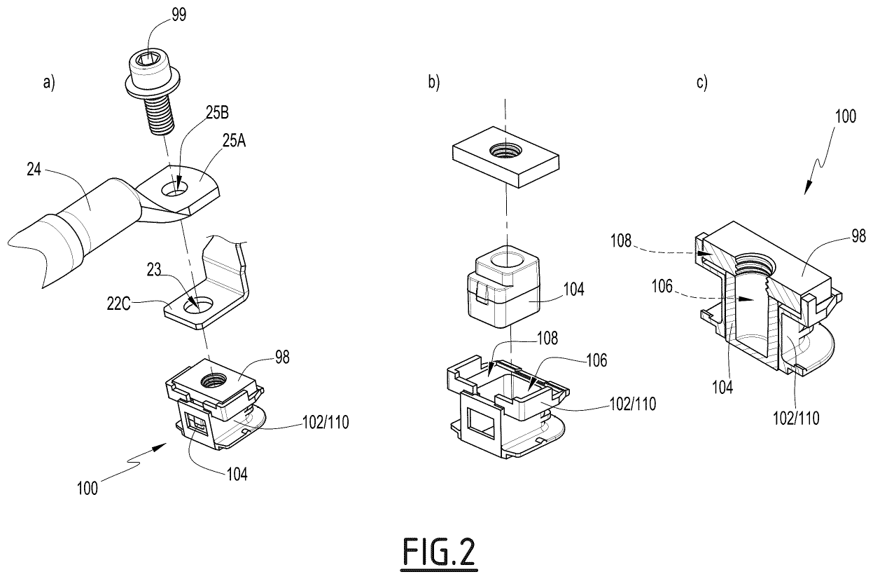

FIG. 2 shows, on three inserts a), b) and c), a connection terminal comprising an overheating detection element, belonging to the electrical equipment shown in FIG. 1, the overheating detection element also being according to the invention;

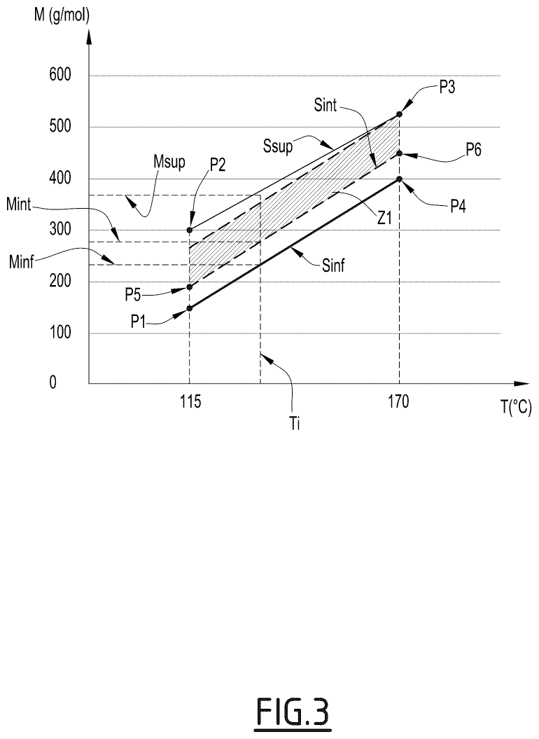

FIG. 3 is a graph illustrating certain properties of a heat-sensitive material used for the manufacture of the overheating detection element of FIG. 2, the heat-sensitive material also being according to the invention, and

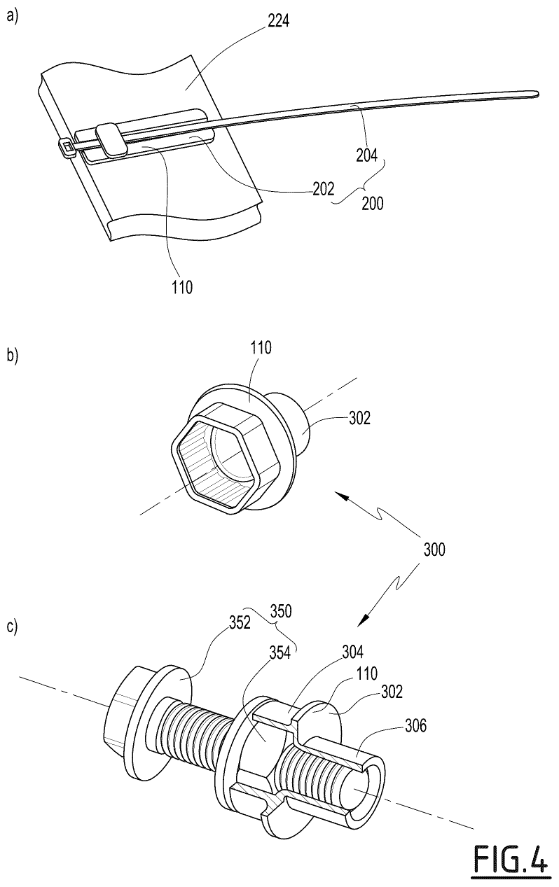

FIG. 4 shows, on three inserts a) and b), c), an overheating detection element according to alternative embodiments of the invention.

An electrical cabinet 10 is shown in FIG. 1. The electrical cabinet 10 is schematically represented by a parallelepiped and delimits an enclosure V10. The electrical cabinet 10 comprises at least a first electrical device 20 and a detection device 30. The electrical device 20 and the detection device 30 are located in the same enclosure—herein the enclosure V10—of the electrical cabinet 10. The electrical device 20 and the detection device 30 are herein fastened onto a panel 12, which forms a bottom of the enclosure V10.

The electrical device 20 comprises at least one connection pad 22, which is configured to be connected to another element of the electrical cabinet 10, e.g. another electrical device of a type identical to the electrical device 20, or another electrical device of a different type, or else to a conductive element such as a cable or a set of metal busbars. In the example illustrated, the electrical device 20 is a three-phase circuit breaker, and the connection pads 22 include four input pads, referenced 22A, 22B, 22C and 22D, and four output pads, which are not visible in the figures.

One of the connection pads 22, herein the input pad 22C, is shown connected to a conductive element 24, herein a cable. What is valid for one of the connection pads 22 can be transposed to the other connection pads. The assembly of the conductive element 24 to the connection pad 22C is explained with reference to FIG. 2a). The fastening pad 22C is part of a metal part of the electrical device 20, the fastening pad 22C protruding outside a housing of the electrical device 20. Only the fastening pad is shown in FIG. 2a), the rest of the electrical device 20 being hidden so as not to overload the figure.

The fastening pad 22C is herein pierced by an orifice 23. The conductive element 24 herein comprises a fastening lug 25A, which is pierced by a hole 25B. The assembly between the fastening pad 22C and the lug 25A is herein achieved by means of a nut 98 and a screw 99. The nut 98 is made herein by a metal plate, with a parallelepiped shape, which has a tapped orifice configured to cooperate with the screw 99.

The nut 98 herein is a part of an overheating detection element 100. The overheating detection element 100 is also simply called the “detection element 100” within the framework of the present description. In the first embodiment of the invention, the detection element 100 comprises, in addition to the nut 98, a main body 102 and a core 104.

The nut 98 is configured to cooperate with the screw so as to tighten the connection pad 22C to the lug 25A. The nut 98 is made of a thermally conductive material. Thereby, in the event of heating of the connection between the connection pad 22C and the lug 25A, e.g. if the screw 99 is not tightened correctly, the nut 98 transmits part of the heat released to the rest of the detection element 100.

The core 104 is made of a material which is thermally conductive and electrically insulating, e.g. ceramic.

The main body 102 forms a first cavity 106, wherein the core 104 is received, and a second cavity 108, which is adjacent to the first cavity 106 and wherein the nut 98 is received, so that the core 104 is in contact with the nut 98. The core 104 serves to transmit the heat from the nut 98 to the main body 102. Thereby, when the nut 98 heats up, e.g. because of a faulty electrical connection, then the entire detection element 100 tends to heat up.

Each main body 102 is made of a heat-sensitive material 110. The heat-sensitive material 110 is hot-injectable and electrically insulating. The heat-sensitive material 110 includes the following ingredients:
a matrix, which is made of a first thermoplastic polymer material having a first melting temperature T1,
a plasticizer, which has a given molecular weight and a second melting temperature T2, the second melting temperature T2 being lower than the first melting temperature T1, and
a filler in the form of particles, more particularly in the form of powder.

The thermoplastic polymer material used for the matrix is e.g. polyamide 66, denoted by PA66, polyamide 6, denoted by PA6, polybutylene terephthalate, denoted by PBT, a thermoplastic elastomer, denoted by TPE, etc. In general, the type of thermoplastic polymer or thermoplastic elastomer used is not limited for the implementation of the invention, as long as the characteristics of rigidity, melting temperature, resistance to aging, heat, electrical insulation, etc. needed for the application are achieved.

In general, in the field of plastics processing, fillers are added to the polymer or elastomer matrix to modify the properties of the material, whether during manufacture, e.g. to facilitate demolding, reduce shrinkage, etc., or else for the final part, e.g. to modify the density, hardness, rigidity, color, etc. thereof within the framework of the present invention, the fillers used are particles, in other words powders, preferably electrically insulating. Preferably, the filler particles used have a diameter comprised between 0.1 μm and 100 μm. Preferably, the filler used within the framework of the present invention comprises carbon black.

The plasticizers are also added to the thermoplastic polymer matrix to modify the properties thereof, in particular the mechanical properties. For each thermoplastic polymer, there are generally a plurality of types of compatible plasticizers, the known selection criteria being in particular the polarity of the plasticizer and the polarity of the thermoplastic matrix, the chemical functions present on the plasticizer and the thermoplastic able to generate chemical bonds. . . . Compatibility can in particular be estimated using Hildebrand's solubility parameters.

Within the scope of the invention, the heat-sensitive material as a whole, and in particular the plasticizer, comply with the European directive RoHS—Restriction of Hazardous Substances—aimed at restricting the use of hazardous substances in electrical and electronic equipment, the European regulation REACH—acronym for Registration, Evaluation, Authorization and Restriction of Chemicals—and does not contain any halogen—as per the standard IEC63355:2022—nor any persistent organic pollutant, as per the European regulation UE 2019/1021—called the Pop regulation.

During the manufacture of the main body 102, the ingredients of the material of the main body are initially mixed with each other by hot mixing, e.g. using an extrusion screw, so as to prepare a homogeneous mixture, preferably in the form of granules. The heat-sensitive material 110 is thereby obtained. The step of preparation of the heat-sensitive material 110 by mixing is also called compounding. During the step of preparing the heat-sensitive material 110, the mixing temperature is advantageously higher, by 30° C. to 50° C., than the first melting temperature T1. Preferably, the plasticizer is liquid at the mixing temperature, so as to promote the integration of the plasticizer into the polymer matrix.

After the step of preparing the heat-sensitive material 110, the heat-sensitive material 110 is considered to be homogeneous. The heat-sensitive material 110 is then used as raw material for the manufacture of the main body 102, which is herein manufactured by hot injection. Thereby, the material of the main body 102 is considered to be homogeneous.

Schematically, after injection and cooling, the thermoplastic polymer forms a matrix which contains the plasticizer and the fillers. When the detection element 100 heats up, the plasticizer releases volatile substances, if the temperature reached is sufficient, one can talk about a beginning of decomposition generating volatiles or gases. Furthermore, such releases can even entrain particles coming from the filler added to the material. Thereof is a gradual process beginning with a migration of plasticizer and filler particles toward the surface of the main body 102, generating sweating, then a release of gas volatiles and filler particles. The volatiles or gases, and the particles coming from the fillers, entrained by the plasticizer flow, are suspended in the enclosure V10 of the electrical cabinet 10.

Surprisingly, it was found that the sweating of the plasticizer and/or of the volatile compounds generated by the plasticizer and/or the filler particles was not a linear function of temperature, but that the amount of plasticizer and/or volatile compounds and/or particles sweated increased suddenly when the temperature of the material exceeded a first predetermined temperature threshold. Surprisingly, it has also been found that the first temperature threshold varies as a function of the molar weight of the plasticizer. The molar weight, denoted by M, is expressed in g/mol—gram per mol—. In other words, the higher the first desired temperature threshold, the higher the molar weight of the plasticizer has to be.

Thereby, within the context of the invention, the molar weight M of the plasticizer is chosen as a function of the first temperature threshold, the first temperature threshold being predetermined, during the design of the detection element 100, by the user, according to the desired application. Preferably, the first temperature threshold is chosen between 125° C. ±10° C. and 160° C. ±10° C., which corresponds to the usual temperatures for monitoring heating in the field of electrical devices and electrical cabinets.

In practice, the thermoplastic polymer material of the matrix is chosen first, in particular according to the technical requirements (mechanical, thermal, fire resistance, etc.) of the part to be manufactured. One or a plurality of plasticizers, the molar weight of which corresponds to the envisaged temperature threshold, are then selected from plasticizers compatible with the polymer material selected, in particular according to the abovementioned criteria of polarity, solubility, etc. Preferably, the degradation temperature of the plasticizer is higher than the use temperature of the material.

The first temperature threshold is strictly lower than a first melting temperature T1 of the thermoplastic polymer matrix. The heat-sensitive material 110 is thereby configured to release around the main body 102 a flow of plasticizer and particles derived from the filler, the particles derived from the filler being entrained by the plasticizer, when the heat-sensitive material 110 is subjected to a temperature greater than the first temperature threshold. The flow of plasticizer and filler thereby released by heating beyond the first temperature threshold can be detected by the detection device 30. In particular, volatile species, such as gases, released by the sipping of the plasticizer, and/or particles entrained by the plasticizer flow, will be detected.

The detection device 30 is configured to detect a flow of plasticizer and/or fillers in the enclosure V10 of the electrical cabinet 10 and is configured to send an alert signal when a concentration of the plasticizer and/or fillers exceeds a predetermined concentration threshold, which indicates that the temperature of the main body 102 exceeds the first temperature threshold. The alert signal is e.g. a sound signal, and/or a visual signal, and/or a signal transmitted in the form of an electronic message via a dedicated interface, either wired or wireless.

The technology used for the detection device 30 is not particularly limited. According to a first example, the detection device 30 includes a detector of volatile organic components, also called VOCs. Advantageously, the detection device 30 is configured to detect the molecules of the plasticizer, which includes the molecules of the plasticizer as such and/or molecules of volatile species released by the plasticizer. According to a second example, the detection device 30 includes an opacimeter, so as to detect the opaque particles suspended in the enclosure, in other words to detect the charges entrained during the sipping of the plasticizer. Of course, several technologies can be combined within the detection device 30 so as to improve the reliability of detection.

According to a first example of application of the invention, for a first temperature threshold comprised between 115° C. and 135° C., in other words for a first temperature threshold equal to 125° C. ±10° C., the molar weight M of the plasticizer is chosen between 150 g/mol and 300 g/mol.

According to a first formulation of the heat-sensitive material 110 of the main body 102 illustrating the first example of application:
the thermoplastic polymer matrix is polybutylene terephthalate—PBT—,
the plasticizer is N-ethyl o/p-toluene sulfonamide, said plasticizer having a molar weight M of 199 g/mol and being added in an amount of 6.75% by weight of the polymer matrix, and
the fillers are carbon black, which is added in the amount of 2% by weight of the complete formulation.

Glass fibers were also added in the amount of 30% by weight of the polymer matrix as well as a halogen-free flame retardant, the addition having not hindered the implementation of the invention. Complete formulation refers to the polymer matrix, the plasticizer, the fillers including the carbon black, as well as other possible elements which are not needed but which contribute to the implementation of the invention, in particular reinforcements such as glass fibers, other additives such as a flame retardant, etc.

The heat-sensitive material 110 is then produced by mixing the above-mentioned ingredients using a heating extruder, in the form of granules. The granules of heat-sensitive material 110 are then used in a hot injection molding machine to manufacture the main body 102 of heat-sensitive material 110.

The main body 102 is then assembled to a core 104 and to the nut 98, so as to obtain an overheating detection element of the type of the overheating detection element 100, which is then mounted on an electrical connection between two conductive elements. An electrical current of controlled intensity flows through the electrical connection so as to cause the heating of the connection, a temperature of the electrical connection being monitored by an infrared detector. It has been verified that the detection device 30 emits an alarm signal when the temperature of the electrical connection reaches the first temperature threshold, herein equal to 125° C. ±10° C.

According to a second formulation of the heat-sensitive material 110 of the main body 102 illustrating the first example of application, the following formulation range serves to manufacture the heat-sensitive material 110 particularly suitable for the detection of heating with a first temperature threshold equal to 125° C. ±10° C.:
the polymer matrix is a polyamide 6-PA6
the plasticizer is N-ethyl o/p-toluene sulfonamide, said plasticizer having a molar weight M of 199 g/mol and being added in an amount of 6.75% by weight of the polymer matrix, and
the fillers are carbon black, which is added in the amount of 2% by weight of the complete formulation.

Glass fibers were also added in the amount of 30% by weight of the polymer matrix as well as a halogen-free flame retardant, the addition having not hindered the implementation of the invention.

More generally, the following formulation range makes it possible to manufacture a 110 heat-sensitive material particularly suitable for the detection of heating with a first temperature threshold equal to 125° C. ±10° C.:
The polymer matrix is a PBT or PA6,
the plasticizer is N-ethyl o/p-toluene sulfonamide added between 4% and 15% by weight relative to the polymer matrix,
the carbon black fillers are added between 2 and 3% by weight of the complete formulation.

According to a second example of application of the invention, for a first temperature threshold comprised between 150° C. and 170° C., in other words for a first temperature threshold equal to 160° C. ±10° C., the molar weight M of the plasticizer is chosen between 400 g/mol and 500 g/mol.

According to a third formulation of the heat-sensitive material 110 illustrating the second example of application:
The matrix is a thermoplastic polyester elastomer—TPE-E—,
The plasticizer is the diisonyl ester of 1.2-cyclohexane dicarboxylic acid (1.2-cyclohexane dicarboxylic acid diisononyl ester), denoted by DINCH, the plasticizer having a molar weight M of 425 g/mol and being added in the amount of 5% by weight of the polymer matrix, and
the fillers are carbon black, which is added in the amount of 2% by weight of the complete formulation.

The same test protocol as for the first application example described hereinabove was implemented. It has been verified that the detection device 30 issues an alarm signal when the temperature of the electrical connection—in other words the temperature of the heat-sensitive material 110—reaches the first temperature threshold, herein equal to 160° C. ±10° C.

According to a fourth formulation of the heat-sensitive material 110 illustrating the second example of application:
the polymer matrix is a thermoplastic polyester elastomer—TPE-E,
The plasticizer is DINCH, the plasticizer having a molar weight M of 425 g/mol and being added in the amount of 15% by weight of the polymer matrix, and
carbon black as fillers, the carbon black being added in an amount of 2% by weight of the complete formulation.

The same test protocol as hereinabove was implemented. It has been verified that the detection device 30 issues an alarm signal when the temperature of the heat-sensitive material 110 reaches the first temperature threshold, herein equal to 160° C. ±10° C.

More generally, the following formulation range makes it possible to manufacture a 110 heat-sensitive material particularly suitable for the detection of heating with a first temperature threshold equal to 160° C. ±10° C.:
the polymer matrix is a thermoplastic polyester elastomer—TPE-E,
The plasticizer is DINCH, added between 4% and 15% by weight relative to the polymer matrix,
the carbon black fillers are added between 2 and 3% by weight of the complete formulation.

FIG. 3 is a graph 180 illustrating, within the framework of the invention, a range of molar weight of the plasticizer, said range of molar weight being given as a function of the first temperature threshold chosen for the heat-sensitive material 110. Thus, the first temperature threshold is on an abscissa axis and the molar weight of the plasticizer is on an ordinate axis. The first temperature threshold and the molar weight define a coordinate system on graph 180.

Thereby, according to the invention, the first threshold and the molar weight are advantageously located inside a quadrilateral delimited by four points:
a first point P1 with the coordinates {115; 150},
a second point P2 with the coordinates {115; 300},
a third point P3 with the coordinates {170; 525}, and
a fourth point P4 with the coordinates {170; 400}, respectively.

The quadrilateral is thereby delimited by a lower segment Sinf, which connects the point P4 to the point P1, and by an upper segment Ssup, which connects the point P2 to the point P3.

To any first intermediate temperature threshold, denoted by Ti, comprised between 115 and 170° C., corresponds a single lower molar weight Minf, which is read on the lower segment Sinf, and a single upper molar weight Msup, which is read on the upper segment Ssup. In other words, when the first temperature threshold is equal to the intermediate temperature Ti, the acceptable molar weight range is comprised between the lower molar weights Minf and the upper molar weights Msup.

Surprisingly, it was found that, for an acceptable range of molar weights associated with a first given intermediate temperature threshold Ti, the higher the molar weight, the less sensitive the overheating detection element 100 was to aging.

Thereby, preferably, in graphical representation, the first temperature threshold and the molar weight are located inside a quadrilateral delimited by four points:
a fifth point P5 with the coordinates {115; 190},
the second point P2 with the coordinates {115; 300},
the third point P3 with the coordinates {170; 525}, and
a sixth point P6 with the coordinates {170; 450}, respectively.

An intermediate segment Sint is defined which connects the fifth point P5 to the sixth point P6. To any first intermediate temperature threshold Ti corresponds a single intermediate molar weight Mint, which is read on the intermediate segment Sint. Thereby, preferably, when the first temperature threshold is equal to the intermediate temperature Ti, the preferred molar weight range is comprised between the intermediate molar weights Mint and the higher molar weights Msup.

Else preferably, in graphical representation, the first intermediate temperature threshold Ti and the molar weight are located in a band bordered on the bottom by the intermediate segment Sint connecting the fifth point P5 to the sixth point P2, the band having a width, measured parallel to the ordinate axis, equal to 75 g/mol. In FIG. 3, the strip is represented by a grayed-out zone Z1.

The invention further relates to a method for detecting heating in the electrical cabinet 10, the detection method comprising:
supplying the electrical cabinet 10,
circulating an electric current through the electrical equipment in such a way as to cause a heating of the heat-sensitive material 110 of the overheating detection element 100 beyond the first temperature threshold Ti and to release, around the detection element 100, a flow of plasticizer and/or volatile species coming from the heated plasticizer and/or from filler particles entrained by the plasticizer,
detecting, by means of the detection device 30, the flow of plasticizer and/or volatile species from the heated plasticizer and/or the filler particles entrained by the plasticizer.

The overheating detection elements 100 according to the invention are particularly advantageous because same serve for the continuous monitoring of the electrical equipment received in the electrical cabinet 10, while remaining inexpensive to install or to manufacture, herein by conventional hot injection means of the main body 102.

An overheating detection element 200, according to a second embodiment of the invention, is represented in FIG. 4a). In the second embodiment, the elements analogous to the elements of the first embodiment have the same references and work in the same way. Hereinafter, the differences between the first and second embodiments are mainly described.

The overheating detection element 200 comprises a main body 202, which is made of a heat-sensitive material similar to the heat-sensitive material 110 of the main body 102 of the overheating detection element 100 according to the first embodiment of the invention, i.e. including:
a polymer matrix, made of a first thermoplastic polymer material having a first melting temperature, and
a plasticizer, having a molecular weight and a second melting temperature, the second melting temperature being lower than the first melting temperature, and
a filler in powder form,
   wherein the molar weight of the plasticizer is chosen according to the first temperature threshold.

The main body 202 herein has the shape of a flattened parallelepiped and is configured to be placed against a conductive element 224, herein a conductive bus. The overheating detection element 200 herein comprises a ligature 204, which serves to fasten the main body 202 to the conductive element 224.

An overheating detection element 300 according to a third embodiment of the invention is represented in FIGS. 4b) 4c). In the third embodiment, the elements analog to the elements of the preceding embodiments have the same references and work in the same way. The differences between the third embodiment and the preceding embodiments are mainly described hereinafter.

The overheating detection element 300 comprises a main body 302, which is made of a heat-sensitive material similar to the heat-sensitive material 110 of the main body 102 of the overheating detection element 100 according to the first embodiment of the invention, i.e. including:
a polymer matrix, made of a first thermoplastic polymer material having a first melting temperature, and
a plasticizer, having a molecular weight and a second melting temperature, the second melting temperature being lower than the first melting temperature, and
a filler in powder form, wherein the molar weight of the plasticizer is chosen according to the first temperature threshold.

The overheating detection element 300 is herein configured to be mounted on a bolt 350, the bolt comprising a screw 352 and a nut 354. The bolt 350 is used e.g. for assembling two conductor buses, or else for assembling a cable to an electrical device, etc. The overheating detection element 300 is herein made in one piece by hot injection, the main body 302 comprising a wall 303, which has overall a ring-shape with a central orifice, the main body 302 comprising a skirt 304, which extends on one side of the wall 303, and a chimney 306, which extends on another side of the wall 303, opposite the skirt 304.

The skirt 304 has the shape of a cylinder with a hexagonal cross-section, the skirt 304 being configured to cooperate, in particular by mating shapes, with the nut 354 so as to fasten the overheating detection element 300 to the nut 354, while one end of a shank of the screw 352 passes through the central orifice of the wall 303 and is received in the chimney 306.

More generally, given the three examples of overheating sensors 100, 200 and 300, it should be understood that the overheating detection elements according to the invention can be shaped in multiple ways, with multiple shapes, so as to facilitate the fitting of the overheating detection elements in an electrical cabinet.

The aforementioned embodiments and variants can be combined with each other so as to generate new embodiments of the invention.

1. A heat-sensitive material for an overheating detection element, wherein:
the heat-sensitive material is an electrically insulating, heat injectable material, the heat-sensitive material including:
a polymer matrix, made of a thermoplastic polymer material or thermoplastic elastomer having a first melting temperature,
a plasticizer, having a molecular weight and a second melting temperature, the second melting temperature being lower than the first melting temperature, and
a filler in the form of particles,
the molar weight of the plasticizer is chosen according to a predetermined first temperature threshold, the first temperature threshold being strictly lower than the first melting temperature, so that the heat-sensitive material is configured to release volatile species coming from the heated plasticizer and filler particles entrained by the plasticizer when the heat-sensitive material is subjected to a temperature higher than the first temperature threshold, said volatile species coming from the plasticizer and from the filler particles being detectable by a detection device.

2. The heat-sensitive material according to claim 1, wherein:
the first temperature threshold is chosen between 125° C. ±10° C. and 160° C. ±10° C.,
for a given first temperature threshold, the molar weight of the plasticizer lies between a minimum value and a maximum value,
on a graph linking the first temperature threshold on an x-axis to the molar weight of the plasticizer on a y-axis, the first temperature threshold and the molar weight define a coordinate system, the first temperature threshold and the molar weight being located within a quadrilateral bounded by four points:
a first point with the coordinates {115; 150},
a second point with the coordinates {115; 300},
a third point with the coordinates {170; 525}, and
a fourth point with the coordinates {170; 400}, respectively.

3. The heat-sensitive material according to claim 2, wherein:
in graphical representation, the first temperature threshold and the molar weight are located within a quadrilateral bounded by four points:
a fifth point with coordinates {115; 190},
the second point with coordinates {115; 300},
the third point with coordinates {170; 525}, and
a sixth point with the coordinates {170; 450}, respectively.

4. The heat-sensitive material according to claim 3, wherein:
in graphical representation, the first temperature threshold and the molar weight are located in a band bordered, on the bottom, by an intermediate segment connecting the fifth point to the sixth point, the band having a width, measured parallel to the ordinate axis, equal to 75 g/mol.

5. The material according to claim 1, wherein:
a degree of addition of the plasticizer is comprised between 4% and 15% by weight relative to the weight of the thermoplastic polymer matrix.

6. The heat-sensitive material according to claim 1, wherein:
the filler is added between 2 and 3% by weight relative to the complete formulation of the heat-sensitive material.

7. The heat-sensitive material according to claim 1, wherein:
the filler is carbon black.

8. The heat-sensitive material according to claim 1, wherein:
the polymer matrix is polyethylene terephthalate,
the plasticizer is DINCH, added between 4% and 15% by weight relative to the polymer matrix.

9. The heat-sensitive material according to claim 1, wherein:
the polymer matrix is polyamide 6/6,
the plasticizer is N-ethyl o/p-toluene sulfonamide, which is added between 4 and 15% by weight of the polymer matrix.

10. The heat-sensitive material according to claim 1, wherein:
the polymer matrix is polybutylene terephthalate,
the plasticizer is N-ethyl o/p-toluene sulfonamide, which is added between 4 and 15% by weight of the polymer matrix.

11. An overheating detection element, comprising a body made of the heat-sensitive material according to claim 1.

12. An electrical equipment item, comprising an electrical conductor configured to let flow through an electrical current, wherein:
the electrical equipment item further comprises an overheating detection element according to claim 11,
the overheating detection element is fastened to the electric conductor.

13. An electrical cabinet, wherein:
the electrical cabinet delimits an enclosure, and comprises:
an electric equipment item according to claim 12;
a detection device, configured to detect the flow of plasticizer and/or fillers released by the heat-sensitive material around the overheat detection element when the temperature of the heat-sensitive material exceeds the first temperature threshold,
the overheating detection element and the detection device are located in the enclosure of the electrical cabinet.

14. A method for the detection of overheating in an electrical cabinet, the detection method comprising:
providing an electrical cabinet according to claim 13,
circulating an electric current through the electrical equipment in such a way as to cause the overheating detection element to heat above the first temperature threshold and to release, around the body made of the heat-sensitive material, a flow of plasticizer and/or volatile species coming from the heated plasticizer and/or from filler particles entrained by the plasticizer,
detecting the flow of plasticizer and/or volatile species from the heated plasticizer and/or filler particles entrained by the plasticizer by means of the detection device.
